(19) United States
(12) Patent Application Publication
(10) Pub. No.: US 2007/0051536 A1
(43) Pub. Date: Mar. 8, 2007

(54) Foldable raceway assembly

(76) Inventor: James W. Williams, Branchburg, NJ (US)

Correspondence Address: B2 PATENT SERVICES, 406 ROSEMONT-RINGOES ROAD, STOCKTON, NJ, 08559, US

(21) Appl. No.: 11/221,211

(22) Filed: Sep. 7, 2005

(51) Int. Cl. H02G 3/08

(52) U.S. Cl. 174/481

(57) ABSTRACT

This invention relates to a flat molded article which is capable of being folded into a rectangular or square tube-like structure useful as a raceway for protecting and concealing electrical or electronic wires. A series of locking mechanisms prevent the structure from being opened once assembled and corresponding stabilizers eliminate the bending and flexing of the raceway after installation. Providing the raceway as a flat article allows long lengths to easily be stored flat or on a roll, making transportation and installation at the construction site easier and time saving.

### BACKGROUND OF THE INVENTION

This invention relates to a molded plastic article with a multiple of membrane hinges and locking mechanisms that will allow the flat molded article to be folded and locked to form a raceway for surface mounted electrical and electronic installations. The article will allow the installer to bring flat sheets or rolls of un-assembled raceway to the job-site and to cut and install the unit as needed without worry about splices and waste. This invention will also allow for easy transport of the flat un-assembled raceway.

### SUMMARY OF THE INVENTION

Raceways are a common article used for the installation of electronic and electrical wires for communication, security, and internet connections. They are typically provided as a two piece rigid plastic in three or four foot lengths. For long runs the short pieces must be connected by either a union or junction box. The molded article of this invention allows for long runs to be contained on a roll. This allows for easy transportation to the job site, a neater looking installation and a time saver for the professional installer.

### BRIEF DESCRIPTION OF THE DRAWINGS

FIG. 1 depicts the article as manufactured flat for packing, storage and transport to the job site. This illustration shows the location of the membrane hinges and locking devices for securing the raceway into a rigid tubular structure.

FIG. 2 depicts the article ready for use after locking into its tubular structure after it would have been secured to the wall.

### DETAILED DESCRIPTION OF THE INVENTION

For the purposes of this invention, a raceway is defined as a surface mounted structure meant to serve as protection for electrical or electronic wires within. The raceway is typically square or rectangular in shape and of a size large enough to contain the wires, but small enough to be as unobtrusive as possible once mounted onto the wall. The final raceway of this invention, once folded into its final form, will be between 1 and 25 cm in width (inside measurement) and 0.25 to 10 cm in height (inside measurement). In an embodiment of this invention the width will be between 2 and 10 cm, the height will be between 0.5 and 5 cm.

Raceways are designed to be used in existing commercial or residential buildings where easy access to the interior of the wall is not a desirable option. They must be able to be secured to the wall and, once closed, they can not be opened without destroying the raceway. This feature is to prevent people from gaining access to the raceway, either accidentally or purposefully. This is accomplished via the locking mechanism shown as 3 and 4 in FIG. 2. One skilled in the art will recognize that other locking mechanisms could be used to accomplish this task, which are covered under the scope of this invention.

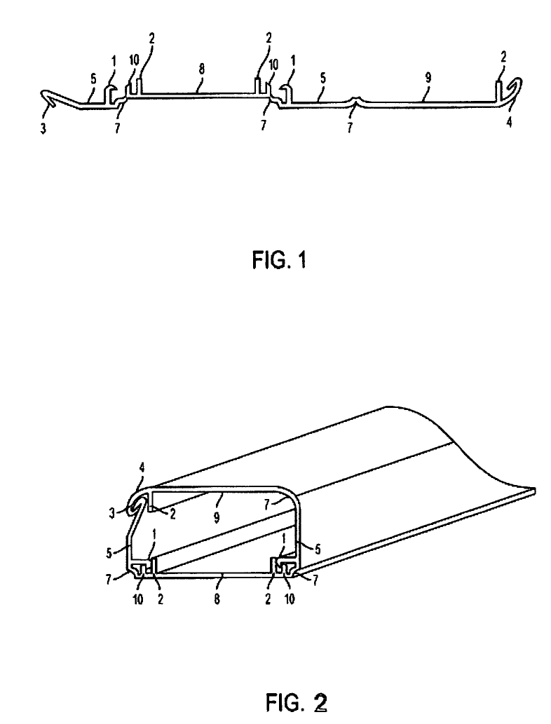

In order for the molded, flat plastic article to be folded into a square or rectangular raceway, such as shown in FIG. 1, there must be at least 3 hinges running the length of the raceway. These hinges are shown as elements 7 on FIG. 2. In an embodiment of this invention, the hinges are membrane hinges. Membrane hinges are defined as a thin line or area in the molding process which allows the plastic to be bent or folded in that specific spot. The material in the membrane hinge is the same polymer or plastic used for the entire construction. In another embodiment of this invention, the hinge is a living hinge. A living hinge is defined as containing a second type of plastic or polymer which is formed into the hinge during the molding process.

The hinges are located between, and used to form a top section (FIG. 2, number 9), a bottom section (FIG. 2, number 8) and a pair of sides (FIG. 2, number 5). The top section and the opposing side section (the side not attached to the top) contain the locking mechanism (FIG. 2, number 3 and 4). Each side section contains a locking mechanism (FIG. 2, number 1) located near the hinge with the bottom section (FIG. 1, number 7). The locking mechanism of the side engages the mechanism of the bottom (FIG. 2, number 10) to prevent the raceway from being opened after installation is complete.

In an embodiment of this invention the hinge area is laminated with a flexible, resilient material running the entire length of the hinge. Additionally the laminate can be placed on either or both surfaces of the hinge (i.e. inside or outside of the raceway). The laminate will allow the hinge to be flexed multiple times without breaking and will provide some small force towards the original position (flat). Alternatively stated, the laminate will provide a small resistance to folding. This resistive force acts to keep the locking mechanism closed once assembled.

The materials used to make the raceway of this invention are generally rigid PVC or polystyrene. In an embodiment of this invention when the raceway is produced from rigid PVC the laminate material is chosen from the group consisting of flexible PVC, Alcryn® MPR (a melt processible rubber available from Advanced Polymer Alloys, Wilmington Del.) and Hytrel® (a polymeric elastomer available from DuPont Engineering Polymers, Wilmington, Del.). In another embodiment when the raceway is produced from polystyrene, the laminate is prepared from a styrene-butadiene copolymer (available under the trade name of Styrolux®, BASF Corp., Mt. Olive N.J.).

To further stabilize the structure and make the raceway rigid a series of stabilizing support bars are molded into the article (FIG. 2, number 2) which run the entire length of the raceway.

What is claimed:

1. A raceway comprising a flat sheet of rigid molded material capable of being folded to form a rectangular or a square tube-like structure; said flat sheet containing a first and a second side member, a bottom member and a top member, wherein the bottom member is connected to the first side member via a hinge connection and the second side member via a hinge connection attached at opposite sides of the bottom member and the second side member is further attached to the top member via a hinge connection located opposite to the hinge connection of the second side with the bottom, said first side and second side members contain a means for locking located near the connecting hinge with the bottom member which engages a locking mechanism located on the bottom member, said top member and first side member contain a mechanism for locking the raceway into the rectangular or the square structure and each of the locking mechanisms contain a stabilizing support bar to prevent bending and flexing.

2. The raceway of claim 1 wherein the rigid molded material is made of rigid PVC.

3. The raceway as described in claim 2, wherein a laminate is placed over one or more of the hinge connections.

4. The laminate of claim 3 wherein the laminate is prepared from a flexible material chosen from the group consisting of flexible PVC, Alcryn® MPR and Hytrel® polyester.

5. The raceway of claim 1 wherein the rigid molded material is made of polystyrene.

6. The raceway as described in claim 5, wherein a laminate is placed over one or more of the hinge connections.

7. The laminate of claim 6 wherein the laminate is prepared from Styrolux®.
